(19) United States
(12) Patent Application Publication
(10) Pub. No.: US 2020/0107217 A1
(43) Pub. Date: Apr. 2, 2020

(54) BASE STATION, COMMUNICATION METHOD AND RECORDING MEDIUM

(71) Applicant: NEC Corporation, Minato-ku, Tokyo (JP)

(72) Inventors: Dileep KUMAR, Tokyo (JP); Naoto ISHII, Tokyo (JP)

(73) Assignee: NEC Corporation, Minato-ku, Tokyo (JP)

(21) Appl. No.: 16/497,852

(22) PCT Filed: Mar. 29, 2017
(86) PCT No.: PCT/JP2017/012944

§ 371 Date: Sep. 26, 2019

(51) Int. Cl. H04W 28/02; H04L 5/00; H04W 72/12

(52) U.S. Cl. CPC H04W 28/0268; H04W 28/0284; H04W 72/121; H04W 72/1252; H04L 5/0048

(57) ABSTRACT

Provided a base station that includes a traffic classification unit configured to classify a plurality of uplink traffic requests from a plurality of user terminals into a predetermined number of classes; a user sorting unit configured to sort one or more user terminals in each class, based on performance metric specific to the each class with the one or more user terminals classified thereinto; a traffic pattern and system load estimation units configured to estimate traffic pattern and system load; and a scheduler unit configured to select one or more user terminals based on information about the traffic pattern and system load and to map the selected one or more user terminals to resource blocks.

### TECHNICAL FIELD

The present invention relates to a base station, communication method and recording medium.

### BACKGROUND

Exploding growth in mobile broadband usage has created a variety of new applications. A large number of smart meters in a smart gird, health monitoring devices and sensor networks are some of key examples. Most of these new applications fall under Machine-to-Machine (M2M) type communication, thus forming so called Internet-of-Things (IoT). It would be highly beneficial for both mobile operator companies and users, if a cellular system can handle traffic from both IoT machines and handheld mobile devices in a unified way, and hence should be capable of handling a variety of connected devices with different traffic profiles and requirements at the same time in a flexible manner. However, designing such integrated radio access and resource allocation system is a challenging problem. Some of key issues are highlighted in the following paragraph.

A traffic characteristic of an IoT machine communication may be said to be basically quite different from that of a typical handheld mobile device communication. Each IoT application has a different Quality of Service (QoS) requirement and traffic pattern. One example is a simple sensor that emits small data packets and is power limited, whereas a video surveillance has a medium to high bandwidth requirement and that does not have any battery life constraint. In another example, such as one of traffic control, e-health and robotic network and so forth, a network needs some mobility supports, whereas data traffic from smart meters requires strict timing constraint. Another issue is that an amount of uplink traffic from IoT machines to a cellular network is relatively much higher than that of downlink traffic from the cellular network to IoT machines. However, Long Term Evolution (LTE) and Long Term Evolution Advanced (LTE-A) were designed basically for wideband applications for handheld devices only, where downlink traffic is typically heavier than uplink traffic. From this, mobile network operators have begun to realize the importance of optimizing network for increasing amount of uplink traffic, since it has become clearer that the uplink has potentials to generate new revenues in future.

Therefore, for the future mobile broadband services, providing a unified cellular access and resource allocation system and also optimizing the uplink data communications are the keys to efficiently utilize limited radio resources and to maximize the operational profits.

One approach that already been adopted in the standards such as Third Generation Partnership Project (3GPP) [Non Patent Literature (NPL) 1] and [NPL 2]. For Release 12 and Release 13 of LTE standards, 3GPP introduce a different user terminal type for integrating IoT machine type communication with a mobile communication system. The primarily focus was on design of low cost, long battery terminals and that system should be capable of supporting a large number of IoT devices, simultaneously. Key features of these new user terminal categories are summarized in FIG. 6 (3GPP rel. 12-13).

These proposals for LTE and LTE-A enables IoT capabilities in the cellular network but limits the support for peak data rates to 1 Mega bits per second (Mbps) and single antenna only and further most of the exiting proposal suggests to restrict the resource access for IoT machines to some fixed orthogonal sub-band [NPL 5].

This limits number of simultaneous IoT machine connections to the number of orthogonal frequency sub-channels reserved for IoT communication. In addition, most of current literatures consider IoT traffic as a single class. However, each IoT application has different QoS requirement and traffic pattern.

Based on the above, it is very important to find ways that are capable of supporting both mobile handheld devices and IoT machines in an efficient and scalable way and thus efficiently utilizing available radio resources. This problem has not been carefully considered in the literature yet and such a technique has not been established, but it will surely become an important research topic for telecom society in the near future.

Patent Literature 1 (PTL 1) discloses channel estimating method in a Code Division Multiple Access (CDMA) based wireless communication system in which a plurality of Mobile Stations (MSs) communicate with a Base Station (BS) on multiple carriers. Each of the MSs transmits to the BS a pilot signal designed to have simultaneous time-domain and frequency-domain responses. The BS is synchronized to the MS using the received pilot signal and performs channel estimation for the MS. PTL 1 is directed to design of the pilot signal such that it can support timing synchronization and channel estimation simultaneously.

PTL 2 discloses a base station allocates certain time and frequency resource to UEs based on traffic type and class, where the “type and class” depends on “regularly scheduled transmission or on-demand transmission”. UEs utilize the allocated time-frequency resources for transmitting PRACH (i.e., regularly scheduled PRACH signal or on-demand PRACH signal). PTL 2 is directed to solution of the problem in access channel, admission control and/or access contention, for UEs of different type and class.

### CITATION LIST

### Patent Literature

[PTL 1]
EP 1555782 A2
[PTL 2]
US 2016/0105908A1

### Non-Patent Literature

[NPL 1]
M. Centenaro, L. Vangelista, A. Zanella and M. Zorzi, “Long-range communications in unlicensed bands: the rising stars in the IoT and smart city scenarios,” in IEEE Wireless Communications, vol. 23, no. 5, pp. 60-67, October 2016.
[NPL 2]
3GPP TS 22.368: “Service requirements for Machine-type Communications (MTC)” 3GPP, March 2016.
[NPL 3]
E. Dahlman, S. Parkvall, and J. Skold, “4G LTE/LTE-Advanced for mobile broadband,” Academic Press, 2011.
[NPL 4]
R. Zhang, “Scheduling for maximum capacity in SDMA/TDMA networks,” IEEE International Conference on Acoustics, Speech, and Signal Processing (ICASSP), 2002.
[NPL 5]
W. Guibene, K. E. Nolan and M. Y. Kelly, “Survey on Clean Slate Cellular-IoT Standard Proposals,” 2015 IEEE International Conference on Computer and Information Technology; Ubiquitous Computing and Communications; Dependable, Autonomic and Secure Computing; Pervasive Intelligence and Computing, Liverpool, 2015, pp. 1596-1599
[NPL 6]
F. Khozeimeh and S. Haykin, “Self-Organizing Dynamic Spectrum Management for Cognitive Radio Networks,” 2010 8th Annual Communication Networks and Services Research Conference, Montreal, QC, Canada, 2010, pp. 1-7.

### SUMMARY OF INVENTION

### Technical Problem

The disclosures of PTL 1-2 and NPLs 1-6 given above are hereby incorporated in their entirety by reference into this specification.

The following analysis is made by the inventor of the present invention.

According to the related arts, reservation of orthogonal frequency sub-channels for IoT machine communications might not be an efficient way to utilize available radio resources.

The maximum number of simultaneously connected IoT devices will be bounded by the number of available sub-channels in the reserved frequency band. Thus, it is difficult to perform dynamic adjustment of resources between handheld mobile terminals and IoT machines. In addition to this, most of the existing literature treats IoT machines as single class users. However, each IoT application has different QoS requirement and traffic profile.

Accordingly, it is one of objects of the present invention to provide a base station, a method and a recording medium enabling to classify mixed traffics in different classes and select candidate user terminals with radio resource allocated thereto.

### Solution to Problem

According to one aspect of the disclosure, there is provided a base station comprising: a traffic classification unit configured to classify a plurality of uplink traffic requests from a plurality of user terminals into a predetermined number of classes; a user sorting unit configured to sort one or more user terminals in each class, based on performance metric specific to the each class with the one or more user terminals classified thereinto; a traffic pattern and system load estimation unit configured to estimate traffic pattern and system load; and a scheduler unit configured to select one or more user terminals, based on information about the traffic pattern and system load and to map the selected one or more user terminals to resource blocks.

According to another aspect of the disclosure, there is provided a communication method by a base station in a wireless communication system including the base station and a plurality of user terminals; the method comprising:

classifying a plurality of uplink traffic requests from the user terminals into a predetermined number of classes;

sorting one or more user terminals in each class, based on performance metric specific to the each class with the one or more user terminals classified thereinto;

estimating traffic pattern and system load; and

selecting one or more user terminals, based on information about the traffic pattern and system load and to map the selected one or more user terminals to resource blocks.

According to another aspect of the disclosure, there is provided a recording medium storing therein a program for causing a computer to execute processing comprising:

classifying a plurality of uplink traffic requests from a plurality of user terminals into a predetermined number of classes;

sorting one or more user terminals in each class, based on performance metric specific to the each class with the one or more user terminals classified thereinto;

estimating traffic pattern and system load; and

selecting one or more user terminals, based on information about the traffic pattern and system load and to map the selected one or more user terminals to resource blocks.

According to the disclosure, the recording medium is a computer-readable non-transitory recording medium such as a semiconductor storage (such as read only memory (ROM), random access memory (RAM), electrically and erasable programmable read only memory (EEPROM)), Hard Disk Drive (HDD), Compact Disc (CD) or Digital Versatile Disc (DVD) in which the program according to the above described third aspect of the disclosure is stored.

### Advantageous Effect of Invention

According to the present invention, it is made possible to divide mixed traffic in different classes and select candidate users with radio resource to be allocated thereto. Still other features and advantages of the present invention will become readily apparent to those skilled in this art from the following detailed description in conjunction with the accompanying drawings wherein only example embodiment of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF DRAWINGS

FIG. 1 is a diagram illustrating an example of a mobile communication system according to an example embodiment of the present invention.

FIG. 2 is a diagram illustrating an arrangement of a base station according to an example embodiment of the present invention.

FIG. 3 is a diagram illustrating operations of the system according to the example embodiment.

FIG. 4 is a flow chart illustrating operations of the base station according to the example embodiment.

FIG. 5 is a diagram illustrating an arrangement of a base station according to the example embodiment.

FIG. 6 summarizes key features of UE categories in Table format based on 3GPP rel. 12-13.

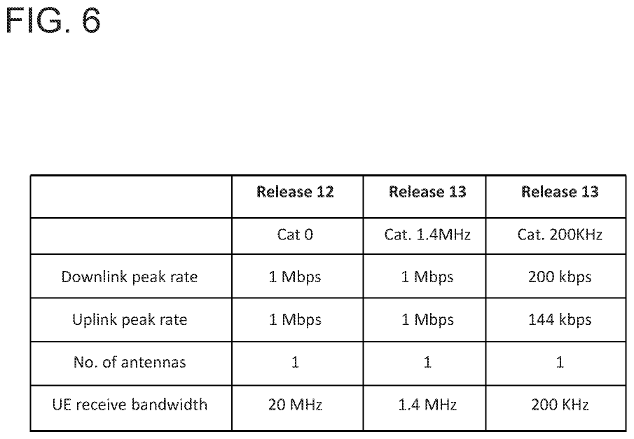

### DESCRIPTION OF EMBODIMENTS

The present invention and its advantages can further be understood with the help of following description of the example embodiments with reference to accompanying illustrative drawings. The following describes a mobile communication system for handheld mobile terminals and IoT machines, as example embodiments, only for the sake of simplicity. The present invention can be applied to any wireless communication system that can use any type of communication equipments as user terminals. Exact structure of an initial access message and the procedure between the terminal and a radio access network or base station, is not the scope of present invention, rather our focus here is only on the uplink scheduling and resource allocation to the set of accepted users in the system. According to example embodiments below described, there may be provided a base station adaptively scheduling set of candidate users terminals (user equipments) including, for example, IoT machines and handheld mobile device, though not limited thereto, in a unified manner for uplink data transmission from an original set of accepted users for each Time-to-Transmit Interval (TTI), to, for example, maximize the user's satisfaction ratio and system throughput while satisfying QoS requirements. According to the example embodiments, there may be provided a unified radio access and radio resource allocation system for the base station capable of handling, for example, both handheld mobile devices and IoT machine traffic, though not limited thereto, in an efficient way. More specifically, provided is a multi-class resource allocation scheme that can treat traffic with similar QoS profile in one class, whether arriving from, for example, handheld mobile devices or IoT machines, though not limited thereto, resulting in efficient utilization of radio resources and support multi-class traffic in a scalable way.

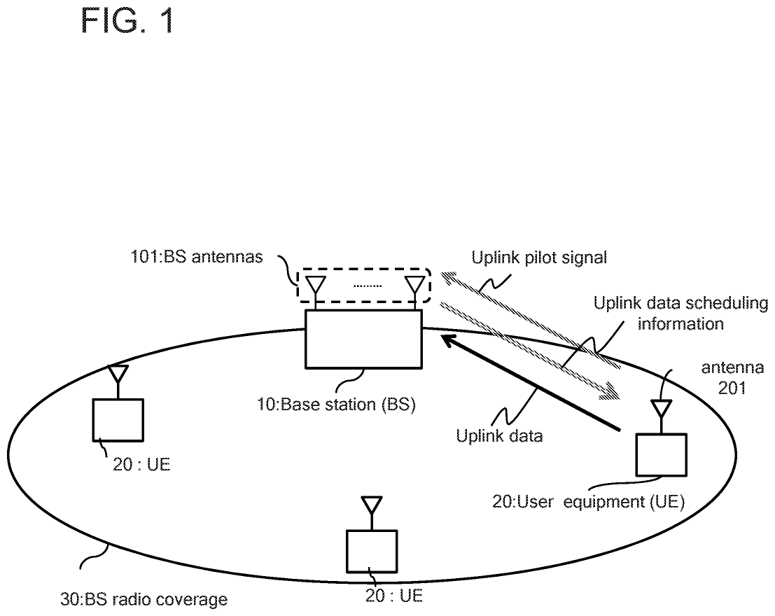

The following describes an example embodiment with reference to drawings. First, a mobile communication system and device, which are used in common for describing the present invention, are described with reference to FIG. 1.

FIG. 1 illustrates an example of a mobile communication system. The system includes a base station (BS) (10) with a plurality of antennas (101), and a user equipment (UE) (20) with a single antenna (201), though not limited thereto. UE (20) may be any user terminal device configured to be able to connect to BS (20), such as, handheld mobile device, IoT device, or the like. Note that usage of UE (20) with single antenna is only for illustrative purpose, and the present invention can be applied to a system including UE (20) with multiple antennas.

Each UE (20) located in a BS radio coverage (30) can communicate with BS (10) in both uplink and downlink directions. More specifically, UE (20) is configured to be able to transmit an uplink pilot signal (equivalent to Sounding Reference Signal (SRS) in LTE system) and Channel State Information (CSI) to BS (10) via the uplink channel.

BS (10) transmits uplink data scheduling information to one or more selected UEs (20), based on a result of performing adaptive time domain scheduling and performing channel estimation on the uplink pilot signal.

Then, UE (20) can transmit uplink data to BS (10), based on the received uplink data scheduling information.

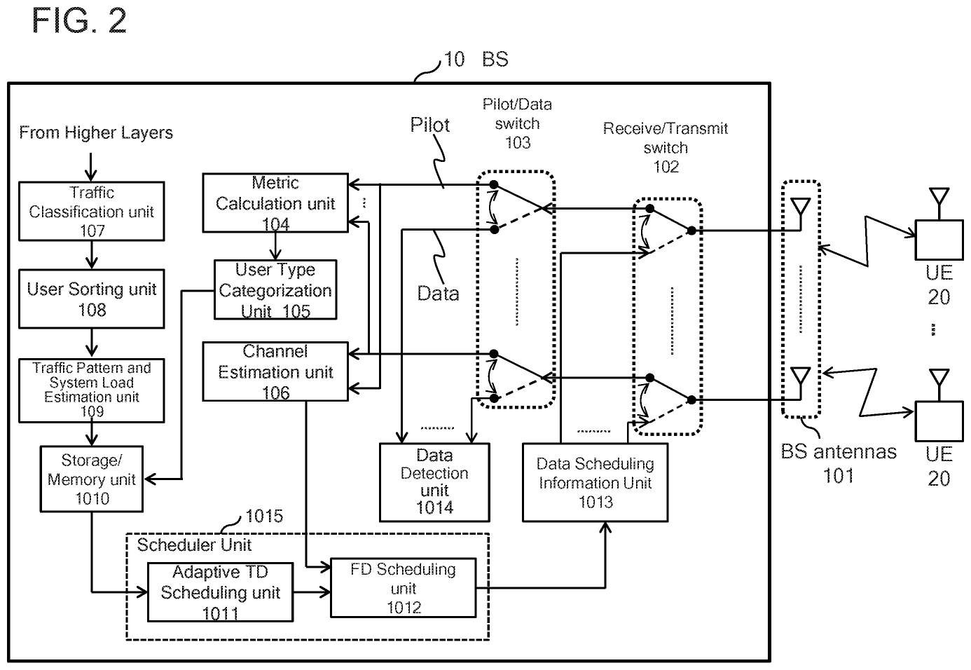

FIG. 2 illustrates a diagram illustrating an arrangement of the BS (10) in FIG. 1. BS (10) is equipped with multiple antennas (also termed as BS antennas) (101) for receiving/transmitting signals from/to UE (20) in uplink/downlink.

The BS (10) includes a receive/transmit switch pilot/data switch (103), metric calculation unit (104), user type categorization unit (105), channel estimation unit (106), traffic classification unit (107), user sorting unit (108), traffic pattern and system load estimation unit (109), storage/memory unit (1010), adaptive time domain scheduling unit (1011), frequency domain scheduling unit (1012), data scheduling information unit (1013), data detection unit (1014), and scheduler unit (1015). The adaptive time domain scheduling unit (1011) and the frequency domain scheduling unit (1012) may constitute a scheduler unit (1015).

The receive/transmit switch (102) controls reception and transmission. The pilot/data switch (103) multiplexes reception between received uplink pilot signal and received uplink data.

Generally, in order to receive uplink data from UEs (20), the BS (10) performs following steps.

The BS (10) receives an uplink pilot signal also known as Sounding Reference Signal (SRS) from UEs (20) in a specified frame.

The metric calculation unit (104) calculates at least one metric, for example, a received Signal-to-Noise Ratio (SNR) of the uplink pilot signal.

The user type categorization unit (105), based on the metric calculated by the metric calculation unit (104), determines a type of the UE (20) from which the pilot signal has been received. The user type categorization unit (105) may be configured to by using the metric, categorize the UE (20) into one of at least two types.

The channel estimation unit (106) performs channel estimation procedure to obtain channel characteristic of each UE (20). Higher layers not shown in mobile communication system provide necessary information, such as traffic type, Quality of Service (QoS) profile, delay requirements and so forth, for each uplink request from UEs (20).

The traffic classification unit (107) then classifies uplink traffics (requests) into a predetermined number of classes, based on the information provided from the higher layers (not shown), such as QoS profile and delay requirements of each uplink request.

The user sorting unit (108) then sorts UEs (20), classified by the traffic classification unit (107), in each class, according to performance metrics specified in each class.

The traffic pattern and system load estimation unit (109) performs traffic characterization in each class to obtain traffic pattern and system load, preferably, on a time scale, i.e., for each Time-to-Transmit Interval (TTI). The traffic pattern and system load estimation unit (109) updates information about traffic pattern and system load in the storage/memory unit (1010) that stores information about traffic pattern and system load, obtained for some previous time intervals.

The adaptive time domain scheduling unit (1011) selects a sub-set of potential UEs (20), based on information about traffic pattern and system load, for a current TTI and some previous TTIs, obtained by the traffic pattern and system load estimation unit (109), so as to maximize system performance metrics and achieve fairness among different classes in the system.

The frequency domain scheduling unit (1012) then maps the one or more UEs (20) selected by the adaptive time domain scheduling unit (1011) to physical resource blocks, based on information about channel estimation obtained by the channel estimation unit (106), and a type for each selected UE (20) determined by the user type categorization unit (105).

The data scheduling information unit (1013) then creates a resource allocation map that contains information items including, for example,

assigned physical radio resources;
precoding vector/matrix;
modulation, coding scheme (MCS); and
minimum uplink power for data transmission.

BS (10) then transmits, to the one or more selected UEs (20) through BS antennas (101), uplink data scheduling information, including such information items, for example, physical resource block (PRB) assignment;

precoding matrix indicator (PMI); and
Modulation Coding Scheme (MCS) index, in LTE terminology.

UE (20) uses the uplink data scheduling information received from BS (10), in order to transmit the uplink data to the BS (10).

Upon reception of the uplink data from UE (20), the data detection unit (1014) in BS (10) performs signal detection. The data detection unit (1014) performs the signal detection by demodulating and decoding the received signal at the assigned physical radio resources. The data detection unit (1014) passes on signal detection result to a higher layer in mobile communication protocol.

In LTE system, reception of the uplink data and signal detection are performed in Physical (PHY) layer and Medium Access Control (MAC) layer, respectively. Then the data from the MAC layer are passed on to the higher layer in mobile communication system.

It is noted here that the present invention provides a technique for BS (10) communicating with any general UE, such as handheld mobile terminal or an IoT machines that are well known, a block diagram for the UE (20) is omitted in the present application.

The following describes an example of operation of the first example embodiment described with reference to FIGS. 1 and 2.

BS (10) first receives an uplink pilot signal from a UE (20) in a specified uplink frame.

The BS (10) then calculates, as a metric, a received signal-to-noise ratio (SNR) of the uplink pilot signal and categorizes, based on the metric, the UE (20) into one of at least two types, type-1 or type-2.

When the received SNR of the uplink pilot signal is below a predetermined threshold value, the BS (10) categorizes a user equipment into type-1. Otherwise, the UE (20) is categorized into type-2. The categorization of UEs (20) into one of at least two types will be later used by the scheduler unit (1015) to perform spatial multiplexing on selected UEs for uplink data transmission.

The BS (10) then classifies traffic requests into a plurality of classes and further categorizes the UEs (20) in each of the classes, based on predetermined class related performance metrics specified by the system.

The BS (10) then selects set of candidate UEs (20), adaptively, for uplink data transmission, based on traffic pattern and system load information.

Finally, the BS (10) creates uplink data scheduling information for the selected user equipments.

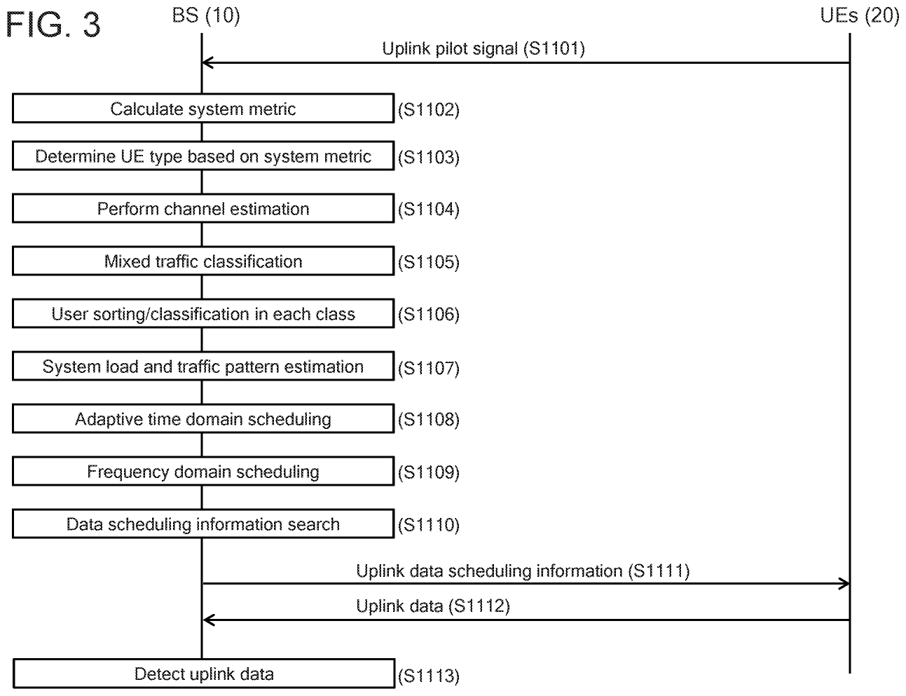

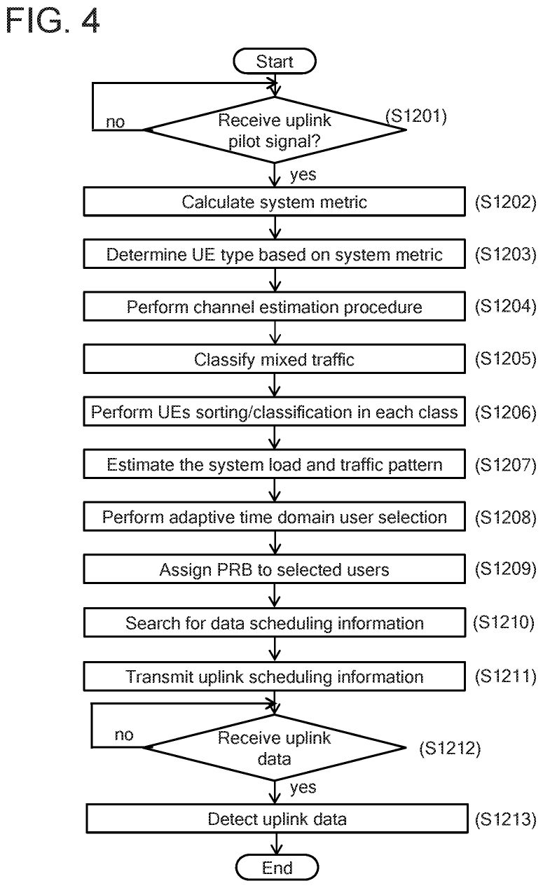

The following describes details of the first example embodiment with references to FIG. 3 and FIG. 4. FIG. 3 illustrates operations for the mobile communication system comprising both BS (10) and the UEs (20) as described with reference to FIGS. 1 and 2.

First, BS (10) receives each of uplink pilot signals from UEs (20) (operation S1101) in a specified uplink frame of LTE/LTE-A frame structure.

BS (10) then calculates a received SNR of the uplink pilot signal (operation S1102). The received SNR of the uplink pilot signal γ_{SNR}(k) where k is a user index (sub-carrier index) may be given as follows:

$$\begin{matrix}{γ}_{SNR} ( k ) = \frac{〈 {\vert y ( k ) \vert}^{2} 〉 - {σ}_{z}^{2} M}{{σ}_{z}^{2} M} & ( Eq . 1 ) \\ y ( k ) = h ( k ) {X}_{p} ( k ) + z ( k ) & ( Eq . 2 ) \\ {h}^{T} ( k ) = [ {H}_{1} ( k ) … {H}_{M} ( k ) ] & ( Eq . 3 ) \\ {z}^{T} ( k ) = [ {Z}_{1} ( k ) … {Z}_{M} ( k ) ] & ( Eq . 4 ) \\ {σ}_{z}^{2} = 〈 {\vert {Z}_{m} ( k ) \vert}^{2} 〉 , \\ where m = 1 , … , M & ( Eq . 5 )\end{matrix}$$

In the above Equations, Xₚ(k) is an uplink pilot signal transmitted by UE (20), where k is a user index (sub-carrier index).

y(k) and z(k) respectively represent a received signal vector with M-elements and noise vector with M-elements, at M antennas of BS antennas (101).

h(k) is a M×1 channel matrix between a single antenna of UE (20) and M antennas of BS (10), where M is the total number of antennas of the BS (10). In a case where UE (20) has N antennas, the channel matrix h(k) is a M×N matrix.

< >, | | and superscript T denote ensemble average, vector norm, and transpose operation, respectively.

σ_{z}², represents the noise power per antenna.

After the received SNR value for the uplink pilot signal for each UE (20) obtained, the BS (10) then performs user type categorization to categorize each UE (20) into one of two types (operation S1103). BS (10) categorizes UE (20) into type-1, when the received SNR of the uplink pilot signal is less than a predefined threshold value, and categorizes UE (20) into type-2, when the received SNR of the uplink pilot signal is not less than the predefined threshold value.

It should be noted, using SNR to categorize UEs into two types is described only for the sake of simplification. UEs may well be categorized into more than two types by using SNR or any other similar performance metrics.

Assuming that a type of UE (20) is denoted as UE_{Type}, where UE_{Type-}1 and UE_{Type-}2 indicate respectively, type-1 and type-2, and a predefined threshold value is γ_{Th}, categorizing UE (20) into one of two types can be expressed as follow.

$${UE}_{Type} = \{ \begin{matrix}{UE}_{Type - 1} , & {γ}_{SNR} ( k ) < {γ}_{Th} \\ {UE}_{Type - 2} , & {γ}_{SNR} ( k ) \geq {γ}_{Th}\end{matrix} \qquad ( Eq . 6 )$$

Next, the BS (10) performs channel estimation (operation S1104) for UEs (20) and obtains, for example, estimates, on a per subcarrier basis, a received signal-to-interference-pluses-noise ratio (SINR). Channel estimation algorithm for finding channel vector estimates for each UE in the uplink such as linear channel estimation (linear detectors (LD) such as Zero Forcing (ZF), Minimum Mean Square Error (MMSE)), iterative channel estimation (Iterative Least Square (LS) channel estimator, Iterative Linear Minimum Mean Square Error (LMMSE) channel estimator), or channel estimation by using interpolation have been extensively studied. The detailed description about the channel estimation procedure is omitted.

The BS (10) then performs traffic classification (operation S1105) to classify uplink traffic requests from applications of UEs (20) into a plurality of classes, preferably, into several classes. In the first example embodiment, it is assumed that traffic classification into different classes is based on UE's QoS requirement profile, such as, minimum required data rate for each request that is extracted by using information obtained from higher layers (such as Open Systems Interconnection (OSI) reference model 7: Application layer).

The following gives one of examples of classes though not limited thereto.

Class-1 may include very high data rate requests from UEs (20), such as a video streaming from an surveillance IoT terminal or a High Definition (HD) application running on handheld mobile device.

Objective of communication by UEs (20) in class-1 will be to achieve a data rate as high as possible with maximum simultaneous transmission.

Class-2 includes moderate data rate UEs (20), such as, a voice call on handheld mobile device, or sensing application running on IoT terminals.

Objective of communication by UEs (20) in class-2 will be to accommodate maximum number of UEs (20) while achieving minimum guaranteed data rate.

The above two objectives contradict with each other and cannot be applied directly to mixed traffic requests from UEs (20) with traffic classification (operation S1105). Similarity, traffic classification (operation S1105) can create several other classes, each having different QoS requirement and objective.

Let Rⱼ be a guaranteed data rate for class-j, that is predefined in advance. The guaranteed data rate for all classes can be written in descending order, as follow,

R₁>R₂> . . . >R_{N} (Eq. 7)

where an index N represents the maximum number of classes in system.

UEₖ (UE (20) with index k) belongs to a specified class j, if and only if the UEₖ satisfies the following requirements,

UE(k)∈class−j if Rⱼ₋₁<rₖ≤Rⱼ (Eq. 8)

where rₖ is the minimum required data rate for UEₖ that is extracted by using information obtained from higher layers.

Note that the reason for QoS assumption is only to simplify the explanation. In fact, traffic classification may be performed based on requirement metric of different UEs. It should also be noted, each UE may generate several types of traffic for uplink that can be easily split into several classes in the similar way.

As mentioned above, each class can have different objective function. For example, class-1 with high data rate requests, will have an objective to maximize achievable data transmission.

BS (10), in the user sorting/classification sorts UEs (20) in each class so as to maximize the respective objective function of each class (operation S1106).

One possible example can be use of Round Robin (RR) will be an optimum choice to sort the UEs (20) in a class containing control information only.

BS (10) then estimates traffic pattern and system load (operation S1107). The mathematical expression for calculation of total load in each class Q_{class-j} and in the system Q_{system} can be respectively expressed, as follow,

Q_{class-j}=Σᵢ₌₁^{K}^{ⱼ}q_{i,j} (Eq. 9-a)

Q_{system}=Σⱼ₌₁^{N}Q_{class-j} (Eq. 9-b)

where q_{i,j} is offered load from UEᵢ to class-j, Kⱼ represents the total number of UEᵢ in class-j, and N represents the maximum number of classes in the system.

The information is calculated for each time to transmit interval (TTI) and stored in a memory (storage/memory unit 1010 in FIG. 2) that is used to make adaptive scheduling decision.

The BS (10) then selects sub set of candidate or potential UEs (20) for uplink data transmission (operation S1108) by using the adaptive time domain scheduling unit (1011).

Most of time domain scheduling algorithms proposed for LTE/LTE-A uplink, makes user selection and/or allocation decision, only based on the information about the traffic characteristics in the current Time-to-Transmit Interval (TTI).

Since, in a case of multi-class and mixed traffics, from several types of UEs including, for an example, IoT machines and handheld mobile terminals; traffic pattern in the system tends to change very rapidly.

To cope with the rapid change in the traffic pattern, scheduling decision performs in an adaptive and in dynamic manner on a very fast time scale, i.e., in each TTI.

To make an intelligent selection, the scheduler unit (1015 in FIG. 2) can also exploit the information on traffic pattern and system load in some of the previous TTI in addition to the information obtained in current TTI. For example, let \hat{ }Bⱼ represents a maximum buffer space for class-j, which is pre-defined for all classes in the system,

dⱼ=\hat{B}ⱼ−Q_{class-j}∀V j∈N (Eq. 10)

where Q_{class-j} can be calculated by using Eq. 9-a, N is the number of classes in the system and V is a universal quantifier wherein ∀j∈N indicates j which is any integer between 1 and N.

After comparison of d₃ for all classes in the system; the scheduler can adapt and allocates more radio resources to a class whose offered traffic is reaching to a buffer limit, i.e., to a class with minimum value of d. By doing this, packet drop can be minimized in future TTI; otherwise packet drop may occur due to buffer overflow.

One possible method to achieve such adaptive allocation is by using learning methods. As one example for learning method, the example embodiment may use Hebbian learning process, which adaptively selects set of potential UEs (20) to distribute radio resources, based on comparison of traffic load in each class, for current time interval, as well as some previous time intervals, which can be easily obtained from the storage/memory unit (1010).

The adaptive time domain scheduling unit (1011) may not only improve QoS provision for different type of traffic, but also may increase system throughput and fairness among different UEs (20) by making more intelligent decision on the selection of UEs (20).

In one example, UEs (20) with comparatively smaller delay budget margin, will be prioritized over UEs (20) with larger delay margin, in an adaptive manner for each TTI.

In another example, as mentioned previously, if traffic in class is approaching to a buffer limit, the adaptive time domain scheduling unit can prioritize such class over all other classes in the system so as to minimize the packet drop rate.

In other words, the adaptive time domain scheduling unit (1011) can take into account at least one of the following criteria: user waiting time, throughput requirements, class occupancy, and exploit multi-class multi-user diversity.

It will help to achieve maximum fairness, lower delay and minimum guaranteed throughput for each user in addition to maximizing the system performance. Regarding Hebbain learning process, reference may be made, for example, to [NPL 6].

The access technique defined by 3GPP for LTE/LTE-A in uplink is single carrier frequency division multiple access (SC-FDMA) to avoid high peak to average power ratio (PAPR). However, it requires the assignment of contiguous resource block to a UE (20).

Contiguity constraint for assignment of more than one Physical Resource Block (PRB) to a UE (20) can be expressed mathematically as follow,

αₖ^{b}(n)−αₖ^{b+1}(n)+αₖ^{y}(n)≤1y=b+2, . . . B∀k,b,n (Eq. 11)

where αₖ^{b} is an indicator variable which takes a binary value,

αₖ^{b}=1, if RB b is allocated to UEₖ, k being a use index,

αₖ^{b}=0, if RB b is not allocated to UEₖ, and

B represents the maximum number PRB in the system.

Next, the BS (10) performs physical resource block allocation, based on UE-type (operation S1109).

If UEs (20) belongs to Type-1, i.e., with the received SNR values of the uplink pilot signals thereof being lower than the predefined threshold, the BS (10) allocates a unique PRB to each of UEs (20), so as to avoid any additional interference such as inter-user interference for uplink data reception at the BS (10).

The unique allocation constraint can be represented mathematically as follow,

Σᵢ₌₁^{K}αᵢ^{m}≤1

where

αᵢ^{m}∈{0,1}i=1, . . . ,K (Eq. 12)

When UEs (20) belong to Type-2, i.e., with the received SNR values of the uplink pilot signals thereof being equal to or above the predefined threshold, BS (10) performs spatial multiplexing operation, where two more UEs (20) can be scheduled simultaneously, and will be assigned same time and frequency radio resource.

Based on user grouping and received SINR on a per sub-carrier basis, the BS (10) then perform a search (operation S1110), by using multi-user diversity in order to determine the combination between number, physical locations, and MCS of assigned subcarrier that maximizes amount of transmittable data with given a predefined relationship therebetween. The search procedure have been studied extensively in the literature, therefore detailed explanation of search operation is omitted in this document for conciseness.

The result of this search is then used to create the uplink data scheduling information and PRB allocation map and is transmitted to all selected UEs (operation S1111).

Next, the UEs (20), upon reception of uplink scheduling information and PRB allocation map, transmits the uplink data to the BS (10) on assigned PRBs (operation S1112).

The BS (10) then performs detection on the uplink data (operation S1113) and obtains required data for higher layers in mobile communication protocols.

The following describes operation of BS (10) with reference to FIG. 4. In step S1201, the BS (10) checks for pilot signal from active UEs (20) at a predetermined interval in specified frames.

Upon reception of pilot signals from UEs (20), the BS (10) estimates the received SNR values of the uplink pilot signal (step S1202).

Based on the estimated SNR values, BS (10) then categorize UEs into two types (step S1203).

After that, BS (10) performs channel estimation (step S1204) and calculates the SINR per sub-carrier for all UEs (20), BS (10) classifies uplink traffic requests into several classes (step S1205) and then performs UE classification in each class (step S1206).

After the classification of the traffic of UEs into different classes, the BS (10) estimates the system load and traffic pattern in each class (step S1207).

Based on this information, BS (10) performs adaptive time domain scheduling and selects set of potential UEs (20) for uplink data transmission (step S1208).

Based on type of UE (20), BS (10) then maps PRBs to selected UE (20) (step S1209) and obtains data scheduling information, such as to maximize an amount of transmittable uplink data for each UE (20) (step S1210).

BS (10) then transmits uplink data scheduling information to the selected UEs (20) (step S1211).

BS (10) checks for uplink data in the specified uplink frame intervals (step S1212). Once the uplink data are received, the BS (10) performs data detection and obtains binary data for higher layers in mobile communication protocols (step S1213).

Details of each operation in FIG. 4 are the same as described above and omitted here for conciseness.

Note that the application of the first example embodiment is not limited to the examples used in the previous explanations. On the contrary, the essence of the first example embodiment can be applied to various scenarios by a person skilled in the related arts.

Based on the explanation of the first example embodiment, it is obvious that service dependent hierarchical spreading of users and traffic into different class results in an efficient utilization of available radio resources in uplink. It provide a unified access and resource allocation scheme that is scalable with number of connected devices from, for example, both handheld mobile and/or IoT machines, though not limited thereto, thus allowing a flexible and dynamic resource allocation among the different user classes and traffic types based on traffic pattern and system load.

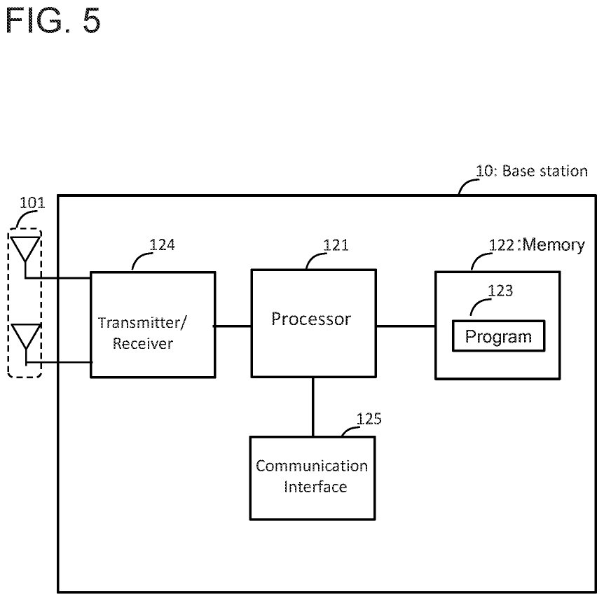

Referring to FIG. 5 illustrating an arrangement of the BS (10) in another example embodiment, the BS (10) includes a processor (121) and a memory (122) that stores at least a program (123) therein. A transmitter/receiver (124) may include a baseband processing unit (not shown) to perform modulation and demodulation and radio frequency (RF) transmission/reception unit (not shown) to perform frequency conversion (up-conversion and down-conversion) and transmission/reception of RF signals to/from multiple antennas (BS antennas) (101). A communication interface (125) is adapted to perform communication between the base station (10) and a core network and/or one or more neighboring BS s (10) using respective predetermined protocols. The processor (121) is so configured to execute instructions of a program (123) stored in the memory (122) to perform functions as described in the above described example embodiment.

The memory (122) is a computer-readable non-transitory recording medium that may include at least of one of a semiconductor memory device, (such as read only memory (ROM), random access memory (RAM), electrically and erasable programmable read only memory (EEPROM), USB (Universal serial bus) flash device, and so forth), Hard Disk Drive (HDD), Solid State Device (SSD), Compact Disc (CD) or Digital Versatile Disc (DVD), and magnetic tape, in which the program (123) (instructions) according to the above described the example embodiment is stored.

Each disclosure of the above-listed Patent Literatures and Non Patent Literatures is incorporated herein by reference. Modification and adjustment of each example embodiment and each example are possible within the scope of the overall disclosure (including the claims) of the present invention and based on the basic technical concept of the present invention. Various combinations and selections of various disclosed elements (including each element in each Supplementary Note, each element in each example, each element in each drawing, and the like) are possible within the scope of the claims of the present invention. That is, the present invention naturally includes various variations and modifications that could be made by those skilled in the art according to the overall disclosure including the claims and the technical concept.

### REFERENCE SIGNS LIST

10 Base station (BS)
20 User Equipment (UE)
30 BS radio coverage
101 BS antenna
103 pilot/data switch
104 metric calculation unit
105 user type categorization unit
106 channel estimation unit
107 traffic classification unit
108 user sorting unit
109 traffic pattern and system load estimation unit
121 processor
122 memory
123 program
124 transmitter/receiver
125 communication interface
201 antenna
1010 storage/memory unit
1011 adaptive time domain scheduling unit
1012 frequency domain scheduling unit
1013 data scheduling information unit
1014 data detection unit
1015 scheduler unit

What is claimed is:

1. A base station comprising:
a processor; and
a memory coupled to the processor and storing a program executable by the processor, wherein the processor, based on the program, is configured to execute;
a traffic classification process to classify a plurality of uplink traffic requests from a plurality of user terminals into a predetermined number of classes;
a user sorting process to sort one or more user terminals in each class, based on performance metric specific to each class, with the one or more user terminals classified thereinto;
a traffic pattern and system load estimation process to estimate traffic pattern and system load; and
a scheduler process to select one or more user terminals, based on information about the traffic pattern and system load and to map the selected one or more user terminals to resource blocks.

2. The base station according to claim 1, wherein the processor is further configured to execute:
a metric calculation process to calculate at least one metric of a received pilot signal from the user terminal; and
a user type categorization process to categorize the user terminal into one of at least two types, based on the metric calculated from the pilot signal by the metric calculation unit, and
a channel estimation process to perform channel estimation procedure to obtain channel characteristic of each of the user terminals;
wherein the scheduler process performs;
a time domain scheduling to select one or more user terminals for uplink data transmission, based on information about traffic pattern and system load; and
a frequency scheduling to map the selected one or more user terminals to physical resource blocks, based on information obtained from the channel estimation, the frequency domain scheduling using categorization of the user terminal into one of at least two type by the user type categorization process to perform spatial multiplexing on selected user terminals for uplink data transmission.

3. The base station according to claim 1, wherein the processor is further configured to execute:
a data scheduling information process to create a resource allocation map to transmit the resource allocation map to the selected one or more user terminals.

4. The base station according to claim 1, wherein the scheduler process changes a priority of the traffic class for resource allocation according to the traffic characteristic.

5. The base station according to claim 1, wherein the traffic pattern and system load estimation process stores the estimated traffic pattern and system load in a storage apparatus to detect traffic characteristic of the user terminal.

6. A communication method by a base station in a wireless communication system including the base station and a plurality of user terminals, the method comprising:
classifying a plurality of uplink traffic requests from the user terminals into a predetermined number of classes;
sorting one or more user terminals in each class, based on performance metric specific to the each class with the one or more user terminals classified thereinto;
estimating traffic pattern and system load; and
selecting one or more user terminals, based on information about the traffic pattern and system load and to map the selected one or more user terminals to resource blocks.

7. The communication method according to claim 6, further comprising:
calculating at least one metric of a received pilot signal from the user terminal;
categorizing the user terminal into one of at least two types, based on the metric, and
performing channel estimation procedure to obtain channel characteristic of each of the user terminals;
performing time domain scheduling to select one or more user terminals for uplink data transmission, based on the information about traffic pattern and system load; and
performing frequency scheduling to map the selected one or more user terminals to physical resource blocks, based on information obtained from the channel estimation, and using categorization of the user terminal into one of at least two type to perform spatial multiplexing on selected user terminals for uplink data transmission.

8. The communication method according to claim 6, comprising
changing a priority of the traffic class for resource allocation according to the traffic characteristic.

9. The communication method according to claim 6, comprising
storing the estimated traffic pattern and system load in a storage device to detect traffic characteristic of the user terminal.

10. A non-transitory recording medium storing therein a program for causing a computer to execute processing comprising:
classifying a plurality of uplink traffic requests from a plurality of user terminals into a predetermined number of classes;
sorting one or more user terminals in each class, based on performance metric specific to the each class with the one or more user terminals classified thereinto; and
estimating traffic pattern and system load; and
selecting one or more user terminals, based on information about the traffic pattern and system load and to map the selected one or more user terminals to resource blocks.

11. The non-transitory recording medium according to claim 10, wherein the program stored therein causes the computer to further execute processing comprising:
calculating at least one metric of a received pilot signal from the user terminal;
categorizing the user terminal into one of at least two types, based on the metric, and
performing channel estimation procedure to obtain channel characteristic of each of the user terminals;
performing time domain scheduling to select one or more user terminals for uplink data transmission, based on the information about traffic pattern and system load; and
performing frequency scheduling to map the selected one or more user terminals to physical resource blocks, based on information obtained from the channel estimation, and using categorization of the user terminal into one of at least two type to perform spatial multiplexing on selected user terminals for uplink data transmission.
